(19) United States
(12) Patent Application Publication
(10) Pub. No.: US 2015/0001760 A1
(43) Pub. Date: Jan. 1, 2015

(54) IN-MOLD-DECORATION METHOD FOR MANUFACTURING COMPOUND MATERIAL ARTICLE

(71) Applicants: HON HAI PRECISION INDUSTRY CO., LTD., NEW TAIPEI (TW); HONG FU JIN PRECISION INDUSTRY (SHENZHEN) CO., LTD ., SHENZHEN (CN)

(72) Inventors: HONG-YE ZHANG, Shenzhen (CN); CHUNG-CHI TSENG, New Taipei (TW)

(73) Assignees: HON HAI PRECISION INDUSTRY CO., LTD., NEW TAIPEI (TW); HONG FU JIN PRECISION INDUSTRY (SHENZHEN) CO., LTD ., SHENZHEN (CN)

(21) Appl. No.: 14/014,380

(22) Filed: Aug. 30, 2013

(30) Foreign Application Priority Data
Jun. 26, 2013 (CN) 2013102587966

(51) Int. Cl. B29C 37/00

(52) U.S. Cl. CPC B29C 37/0032
USPC 264/257

(57) ABSTRACT

A method to manufacture a compound material article decorated with patterns includes providing a fiber cloth impregnated with resin, providing a carrier film with a pattern layer, placing the fiber cloth and the carrier film in a hot-press die, closing the hot-press die to adhere the carrier film to a side surface of the fiber cloth, cooling the hot-press die, and opening the hot-press die to release the carrier film from the fiber cloth. The pattern layer adheres to the side surface of the fiber cloth.

### BACKGROUND

1. Technical Field

The disclosure relates to a method for manufacturing compound material articles.

2. Description of Related Art

Plastic articles are reinforced by adding fibers. Plastic articles formed in an injection mold have coarse surfaces because of fibers at the surface of the compound material article. Therefore, it is difficult to decorate the coarse surfaces.

### BRIEF DESCRIPTION OF THE DRAWINGS

FIG. 1 is a flowchart of a first embodiment of a method for manufacturing a compound material article.

FIG. 2 is a schematic view showing the method of the first embodiment of FIG. 1.

FIG. 3 is a flowchart of a second embodiment of a method for manufacturing a compound material article.

FIG. 4 is a schematic view showing the method of the second embodiment of FIG. 3.

### DETAILED DESCRIPTION

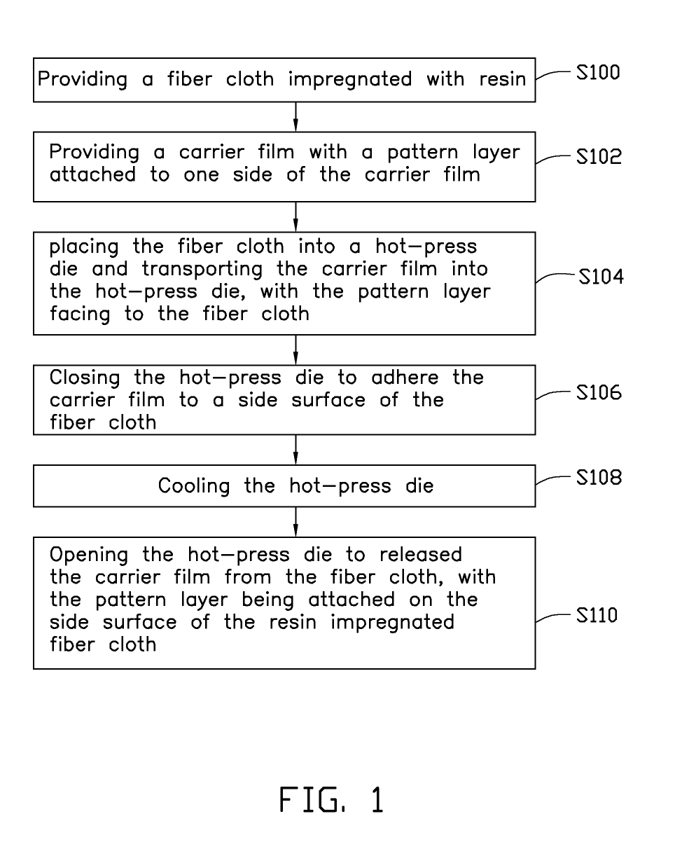

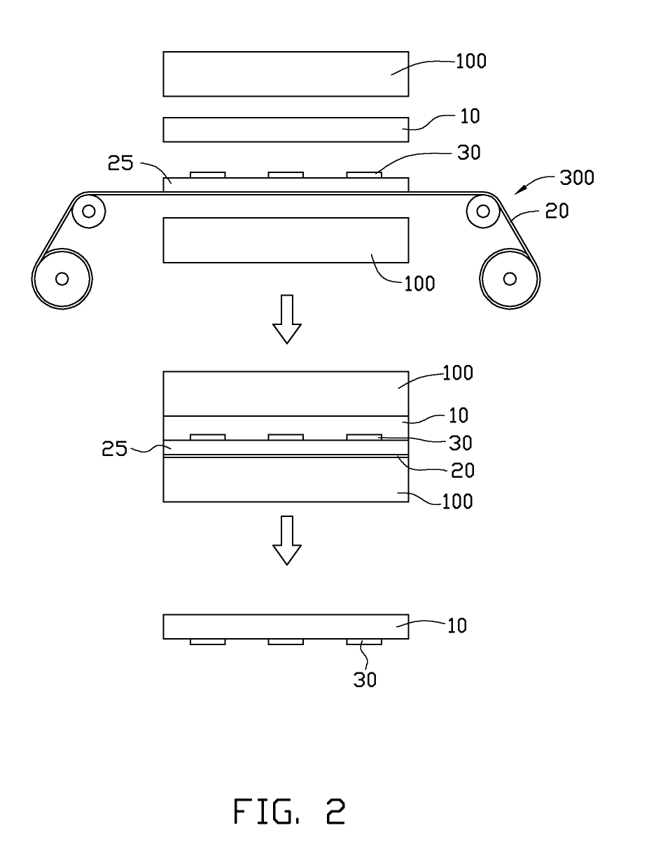

Referring to FIG. 1 and FIG. 2, a first embodiment of a method is utilized to manufacture a compound material article decorated with patterns and/or symbols, such as characters. The method includes the following steps.

In step 100, a fiber cloth 10 impregnated with resin 10 is provided, wherein the fiber cloth 10 is selected from the group consisting of carbon fiber cloth impregnated with thermoplastic resin, glass fiber cloth impregnated with thermoplastic resin, and unidirectional ruled cloth impregnated with thermoplastic resin.

In step 102, a carrier film 20 is provided, wherein a pattern layer 30 with patterns and symbols printed thereon is attached to one side of the carrier film 20. The pattern layer 30 is provided by printing ink on the carrier film 20. In other embodiments, a metal decoration layer is provided as the pattern layer 30, by plating aluminum, chromium, copper, nickel, indium, or tin, alone or in combination, on the carrier film 20 by vacuum evaporation or electroplating.

In step 104, the fiber cloth 10 impregnated with resin is placed in a hot-press die 100, and the carrier film 20 is placed in the hot-press die 100 by a roller transport 300, such that the pattern layer 30 faces the fiber cloth 10.

In step 106, the hot-press die 100 is closed to adhere the carrier film 20 to a side surface of the fiber cloth 10.

In step 108, the hot-press die 100 is cooled.

In step 110, the hot-press die 100 is opened, and the carrier film 20 is released from the fiber cloth 10. The pattern layer 30 is adhered to the side surface of the fiber cloth 10, wherein a release layer 25 can be set between the carrier film 20 and the pattern layer 30 to help release the pattern layer 30 from the carrier film 20.

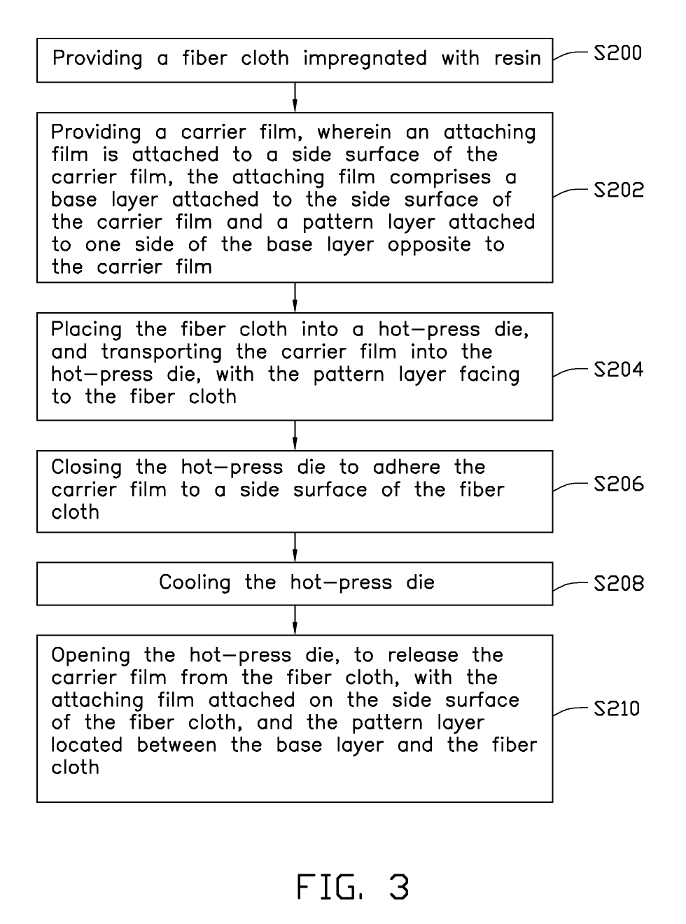

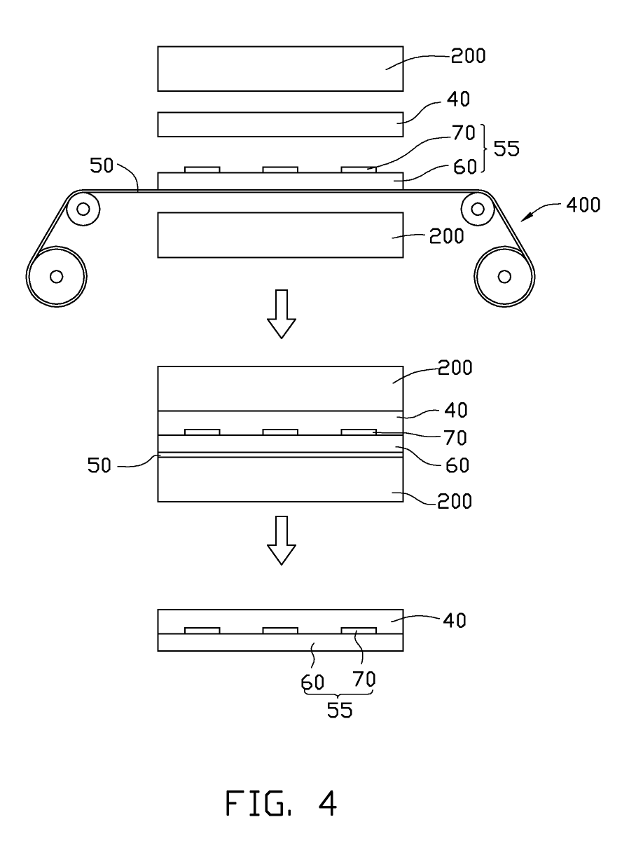

Referring to FIG. 3 and FIG. 4, a second embodiment of a method is utilized to manufacture a compound material article decorated with patterns and/or symbols. The method includes the following steps.

In step 200, a fiber cloth 40 impregnated with resin is provided, wherein the fiber cloth 10 is selected from the group consisting of carbon fiber cloth impregnated with thermoplastic resin, glass fiber cloth impregnated with thermoplastic resin, and unidirectional ruled cloth impregnated with thermoplastic resin.

In step 202, a carrier film 50 is provided, wherein an attaching film 55 is attached to a side of the carrier film 50. The attaching film 55 includes a transparent or semitransparent base layer 60 attached to the side surface of the carrier film 50, and a pattern layer 70 with patterns and symbols printed thereon attached to one side of the base layer 60 opposite to the carrier film 50. The pattern layer 70 is provided by printing ink on the base layer 60. In other embodiments, a metal decoration layer can also be provided as the pattern layer 70 by plating aluminum, chromium, copper, nickel, indium, or tin, alone or in combination, on the base layer 60 by vacuum evaporation or electroplating.

In step 204, the fiber cloth 40 is placed in a hot-press die 200, and the carrier film 50 is placed in the hot-press die 200 by a roller transport 400, with the pattern layer 70 facing the fiber cloth 40.

In step 206, the hot-press die 200 is closed to adhere the carrier film 50 to a side surface of the fiber cloth 40.

In step 208, the hot-press die 200 is cooled.

In step 210, the hot-press die 200 is opened, and the carrier film 50 is released from the fiber cloth 40. The attaching film 55 is adhered to the side surface of the fiber cloth 40, with the pattern layer 70 located between the base layer 60 and the fiber cloth 40.

It is believed that the present embodiments and their advantages will be understood from the foregoing description, and it will be apparent that various changes may be made thereto without departing from the spirit and scope of the description or sacrificing all of its material advantages, the examples hereinbefore described merely being exemplary embodiments.

What is claimed is:

1. A method for forming a compound material article, comprising:
providing a fiber cloth impregnated with resin;
providing a carrier film with a pattern layer attached to one side of the carrier film;
placing the fiber cloth into a hot-press die and transporting the carrier film into the hot-press die, with the pattern layer facing to the fiber cloth;
closing the hot-press die to adhere the carrier film to a side surface of the fiber cloth;
cooling the hot-press die; and
opening the hot-press die to released the carrier film from the fiber cloth, with the pattern layer being attached on the side surface of the resin impregnated fiber cloth.

2. The method of claim 1, wherein the fiber cloth is selected from the group consisting of carbon fiber cloth impregnated with thermoplastic resin, glass fiber cloth impregnated with thermoplastic resin, and unidirectional ruled cloth impregnated with thermoplastic resin.

3. The method of claim 1, wherein the pattern layer is provided by printing ink on the carrier film.

4. The method of claim 1, wherein a metal decoration layer is provided as the pattern layer through plating any of aluminum, chromium, copper, nickel, indium, and tin, alone or in combination, on the carrier film through vacuum evaporation method or electroplating method.

5. The method of claim 1, wherein a release layer is set between the carrier film and the pattern layer, for easily releasing the pattern layer from the carrier film.

6. A method for forming a compound material article, comprising:
providing a fiber cloth impregnated with resin;
providing a carrier film, wherein an attaching film is attached to a side surface of the carrier film, the attaching film comprises a base layer attached to the side surface of the carrier film and a pattern layer attached to one side of the base layer opposite to the carrier film;
placing the fiber cloth into a hot-press die, and transporting the carrier film into the hot-press die, with the pattern layer facing to the fiber cloth;
closing the hot-press die to adhere the carrier film to a side surface of the fiber cloth;
cooling the hot-press die; and
opening the hot-press die, to release the carrier film from the fiber cloth, with the attaching film attached on the side surface of the fiber cloth, and the pattern layer located between the base layer and the fiber cloth.

7. The method of claim 6, wherein the fiber cloth is selected from the group consisting of carbon fiber cloth impregnated with thermoplastic resin, glass fiber cloth impregnated with thermoplastic resin, and unidirectional ruled cloth impregnated with thermoplastic resin.

8. The method of claim 6, wherein the pattern layer is provided by printing ink on the carrier film.

9. The method of claim 6, wherein a metal decoration layer is provided as the pattern layer through plating any of aluminum, chromium, copper, nickel, indium, and tin, alone or in combination, on the carrier film through vacuum evaporation method or electroplating method.

10. The method of claim 6, wherein the base layer is transparent or semitransparent.
